(19) United States
(12) Patent Application Publication
(10) Pub. No.: US 2003/0063050 A1
(43) Pub. Date: Apr. 3, 2003

(54) Gas discharge tube and drive method therefor

(76) Inventors: Kazuo Tomida, Tokyo (JP); Masaki Hirohashi, Kyouto-shi (JP); Jun Kuwata, Tokyo (JP); Hiroko Imamura, Kawasaki-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/253,495

(22) Filed: Sep. 25, 2002

(30) Foreign Application Priority Data
Sep. 28, 2001 (JP) 2001-301749

(51) Int. Cl. G09G 3/28

(52) U.S. Cl. 345/60

(57) ABSTRACT

Disclosed are a gas discharge tube used for the backlight of a liquid crystal display (LCD) or the like and a drive method for the same. A flat type gas discharge tube comprises two plane glasses, a barrier and at least one electrode group comprised of a plurality of parallel electrodes. Voltages are applied to each electrode group in one discharge period in such a way that discharges of a rare gas dispersed spatially and along the time are allowed to occur. Even when a single gas discharge tube is used for the backlight of an LCD having a large display area, therefore, it does not suffer luminance unevenness and the locations of discharge can be dispersed spatially and along the time, thus ensuring a high emission efficiency. As the backlight does not require a light guide plate or a diffusion sheet, its manufacturing cost becomes lower.

### BACKGROUND OF THE INVENTION

1. Field of the Invention

The present invention relates to a gas discharge tube which is used for the backlight or the like of a liquid crystal display (hereinafter referred to as “LCD”) and a drive method for the gas discharge tube, and, more particularly, to the structure of the backlight and a drive method therefor. 2. Description of the Related Art

As shown in FIG. 10, a conventional backlight for a LCD comprises a straight pipe type or L-shaped cold-cathode discharge tube 902 at whose periphery a reflector 901 is arranged, a light guide plate 904 and a diffusion sheet 903. The cold-cathode discharge tube 902 is laid at the peripheral portion of a display and light is deflected vertically by the light guide plate 904 and uniform light emission is provided by the diffusion sheet 903.

As LCDs are used in TV sets or monitors for personal computers, however, the display area increases and is likely to become larger than a 20-inch type. The increased display area makes the vertical deflection by the light guide plate 904 uneven so that it is bright near the cold-cathode discharge tube 902 but gets darker as the location of emission goes away from the cold-cathode discharge tube 902. As a solution to this shortcoming, there has been proposed a method which does not use a light guide plate and uses several cold-cathode discharge tubes 902 and a plurality of diffusion sheets 903 to acquire uniform light emission. However, variations in the properties of the cold-cathode discharge tubes 902 and drive circuits require some measures to improve the production precision of the cold-cathode discharge tubes 902 in order to acquire uniform light emission. This requirement undesirably results in an increase in the manufacturing cost of backlights.

There is a single flat type gas discharge tube which comprises two plane glasses and a barrier. Being a single light emitting device, this gas discharge tube has an advantage of uniform luminance. However, a flat type gas discharge tube of 20 inches or larger should use a plurality of electrodes in order to reduce the discharge start voltage and keep the distances among the electrodes constant.

FIG. 11 shows the structure of a flat type gas discharge tube which has a front glass plate 1101 formed of a plane glass, a fluorescent layer 1102 which emits light based on ultraviolet excitation, a back glass plate 1103 formed of a plane glass, parallel electrodes 1104a and 1104b laid in parallel on the back glass plate 1103, a dielectric layer 1105 which covers the parallel electrodes 1104a and 1104b, a barrier 1106 which seals the front glass plate 1101 and back glass plate 1103, and discharge space 1107 which is surrounded by the glass plate 1101, the back glass plate 1103 and the barrier 1106 and is filled with a rare gas. The number of the parallel electrodes is set to six in FIG. 11 as an example.

FIG. 12 shows the waveforms of voltages to be applied to the flat type gas discharge tube in FIG. 11. In FIG. 12, (a) shows the waveform of a voltage to be applied to the parallel electrodes 1104a and (b) shows the waveform of a voltage to be applied to the parallel electrodes 1104b. Both voltages are applied alternately every T/2 or a half a voltage application period T The reason for this particular voltage application is as follows. While discharge starts after application of a voltage to the electrode, a positive charge and a negative charge, which are called wall charges, are stored in the dielectric layer in accordance with the potential of the electrode and cancel out the applied voltage, thereby stopping discharging. To permit discharge to occur again, therefore, the polarity of the applied voltage is inverted. Although the pulse width of the applied voltage in FIGS. 12A and 12B is narrower than T/2, the applied voltage can take any pulse width which is equal to or narrower than T/2 and causes discharge.

When the voltages in FIGS. 12A and 12B are applied to the parallel electrodes, the spread of discharge at the end or peripheral portions of the discharge space 1107 of the flat type gas discharge tube differs from the spread of discharge at the center portion of the discharge space 1107 (the discharge space excluding the end or peripheral portions), thereby providing a luminance difference. The reason will be discussed below referring to FIGS. 13A and 13B.

FIGS. 13A and 13B show the spreads of discharges caused by the applied voltages and relative luminance values. Reference numeral “1201” indicates the spreading direction of the discharge and a discharge state or a relative luminance value. The relative luminance value is given with “100” being a luminance value obtained in a period T in one discharge zone at the center portion of the flat type gas discharge tube (the space between adjoining electrodes). As two discharges occur in the period T in the same discharge zone, the relative luminance value provided by a single discharge in one discharge zone at the center portion is taken as “50”.

FIG. 13A shows a discharge state which occurs when the voltage in FIG. 12A is applied to the parallel electrodes 1104a and FIG. 13B shows a discharge state which occurs when the voltage in FIG. 12B is applied to the parallel electrodes 1104b.

As the voltage in FIG. 12A is applied to the parallel electrodes 1104a in FIG. 13A, the discharge spreads from the parallel electrode 1104a to the parallel electrodes 1104b on both sides, except for the area near the parallel electrode at the left-hand end. Because the parallel electrode 1104b is laid only on one side (right-hand side in the diagram) with respect to the parallel electrode 1104a, however, the relative luminance value at the left-hand end of the panel becomes greater than those in the other discharge states.

As the voltage in FIG. 12B is applied to the parallel electrodes 1104b in FIG. 13B, as in the case of FIG. 13A, the discharge spreads from the parallel electrode 1104b to the parallel electrodes 1104b on both sides, except for the area near the parallel electrode at the right-hand end. Because the parallel electrode 1104a is laid only on one side (left-hand side in the diagram) with respect to the parallel electrode 1104b, however, the relative luminance value at the right-hand end of the panel becomes greater than those in the other discharge states, as per the case of FIG. 13A. This brings about a problem such that the luminance of light emitted at the end or peripheral portions becomes higher than the luminance at the center portion.

As apparent from the above, the conventional backlight of an LCD with a large display area as shown in FIG. 10 produces a luminance mottle or uneveness and would inevitably result in an increase in manufacturing cost if a plurality of diffusion sheets were used as one way of eliminating the luminance mottle. Even the backlight in FIG. 11 should face the problem of a luminance mottle or a higher luminance at the end or peripheral portions.

### SUMMARY OF THE INVENTION

Accordingly, it is an object of the invention to provide a low-cost gas discharge tube which can be adapted to a backlight with a large display area and is free of a luminance mottle, and a drive method for the gas discharge tube.

A single gas discharge tube according to the invention, which comprises two plane glasses and a barrier, is provided with at least one electrode group comprised of a plurality of parallel electrodes and is designed in such a way that voltages are applied to each electrode group at different timings, so that discharges are dispersed spatially and along the time.

The design can allow a single gas discharge tube to be used for the backlight of an LCD having a large display area, eliminates luminance unevenness and requires no light guide plate or diffusion sheet. It is therefore possible to provide a backlight with a low manufacturing cost.

According to the first aspect of the invention, there is provided a drive method for a gas discharge tube which has two plane glasses, discharge space having a rare gas filled between the plane glasses and a plurality of parallel electrodes arranged on one of the plane glasses and formed into at least one electrode group comprised of at least five parallel electrodes, whereby discharges of the rare gas dispersed spatially and along time are allowed to occur in one electrode group and within one discharge period. The discharges of the rare gas can be dispersed spatially and along the time, which brings about an advantage that a single gas discharge tube can provide a backlight with uniform luminance.

In this drive method, after a second rare gas discharge is allowed to occur at a place other than a place where a first rare gas discharge has occurred, a third rare gas discharge may be allowed to occur within a predetermined period at the place where the first rare gas discharge has occurred. The drive method has an advantage that an increase in luminance at the end or peripheral portions of the discharge space can be suppressed to thereby provide a gas discharge tube with uniform luminance.

According to the second aspect of the invention, there is provided a drive method for a gas discharge tube which has two plane glasses, discharge space having a rare gas filled between the plane glasses, a plurality of parallel electrodes arranged on one of the plane glasses and formed into at least one electrode group comprised of at least three parallel electrodes, and auxiliary electrodes which are located at end or peripheral portions of the discharge space and to which a predetermined voltage is not applied, whereby spatially dispersed discharges of the rare gas are allowed to occur. The drive method can adjust the discharge balance and thus has an advantage that an increase in luminance at the end or peripheral portions of the discharge space can be suppressed.

In the drive method according to the second aspect, the auxiliary electrodes may be laid out at narrower intervals than layout intervals of the parallel electrodes. The drive method can advantageously suppress a reduction in luminance at the end or peripheral portions of the discharge space due to a reduced number of discharges.

In the drive method according to the second aspect or the modification thereof, voltages may be applied to each electrode group in such a way that a voltage applied to a center portion of the discharge space is set lower than a predetermined voltage and a voltage applied to a peripheral portion of the discharge space is set higher than the predetermined voltage. The drive method has an advantage of suppressing a reduction in luminance at the end or peripheral portions of the discharge space to thereby provide a gas discharge tube with uniform luminance.

In the drive method according to any one of the second aspect and the modifications of the first and second aspects, a time of application of a voltage to each electrode group per unit time may be set longer for a center portion of the discharge space than for end or peripheral portions of the discharge space. The drive method has an advantage of suppressing a reduction in luminance at the end or peripheral portions of the discharge space to thereby provide a gas discharge tube with uniform luminance.

According to the third aspect of the invention, there is provided a gas discharge tube comprising two plane glasses; discharge space having a rare gas filled between the plane glasses; a plurality of parallel electrodes arranged on one of the plane glasses and formed into at least one electrode group comprised of at least three parallel electrodes; and auxiliary electrodes which are located at end or peripheral portions of the discharge space and to which a predetermined voltage is not applied, whereby spatially dispersed discharges of the rare gas are allowed to occur. The discharges of the rare gas can be dispersed spatially, which brings about an advantage that a single gas discharge tube can provide a backlight with uniform luminance.

### BRIEF DESCRIPTION OF THE DRAWINGS

FIGS. 1A to 1E are diagrams showing the discharge states of a flat type gas discharge tube according to a first embodiment of the invention;

FIG. 2 is a timing chart of voltages to be applied to the electrodes of the flat type gas discharge tube according to the first embodiment;

FIG. 3 is a diagram illustrating the structures of the flat type gas discharge tube and a drive circuit according to the first embodiment;

FIGS. 4A to 4C are diagrams showing the discharge states of a flat type gas discharge tube according to a second embodiment of the invention;

FIG. 5 is a timing chart of voltages to be applied to the electrodes of the flat type gas discharge tube according to the second embodiment;

FIGS. 6A to 6C are diagrams showing the discharge states of a flat type gas discharge tube according to the second embodiment;

FIG. 7 is a diagram showing the layout of the electrodes of the flat type gas discharge tube according to the second embodiment;

FIGS. 8A to 8C are timing charts of voltages to be applied to the electrodes of the flat type gas discharge tube according to the second embodiment;

FIGS. 9A to 9C are timing charts of voltages to be applied to the electrodes of the flat type gas discharge tube according to the second embodiment;

FIG. 10 is a cross-sectional view illustrating the structure of a backlight for an LCD according to one prior art;

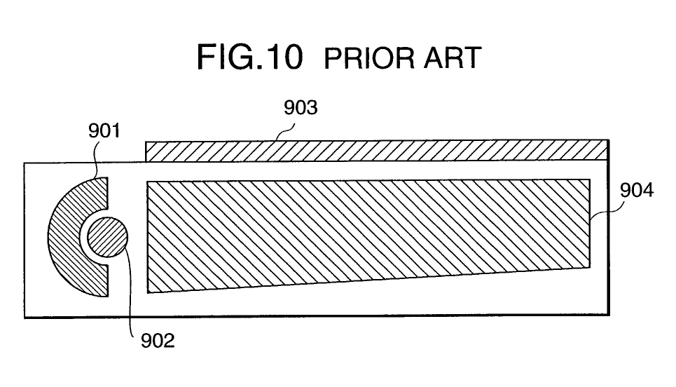

FIG. 11 is a cross-sectional view illustrating a flat type gas discharge tube according to another prior art;

FIG. 12 is a timing chart of voltages to be applied to the electrodes of the flat type gas discharge tube according to the second prior art;

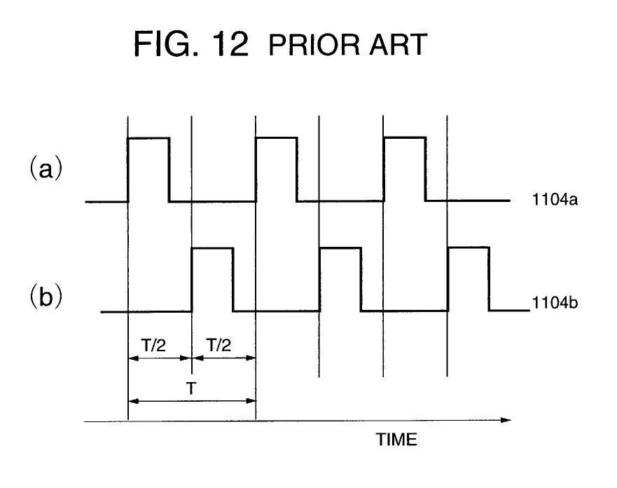

FIGS. 13A and 13B are diagrams showing the discharge states of the flat type gas discharge tube according to the second prior art.

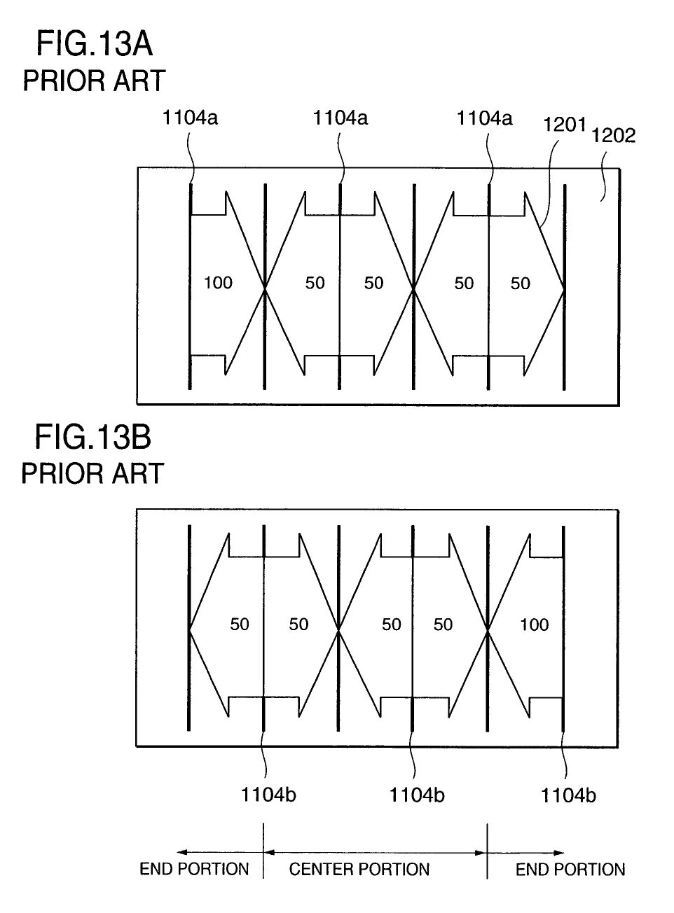

### DETAILED DESCRIPTION OF THE PREFERRED EMBODIMENTS

Preferred embodiments of the invention will now be described with reference to the accompanying drawings.

First Embodiment

The first embodiment of the invention suppresses an increase in luminance at the end or peripheral portions of a flat type gas discharge tube used for the backlight of a liquid crystal display (LCD) by dispersing discharge-originated light emission along the time and spatially by using a plurality of parallel electrodes.

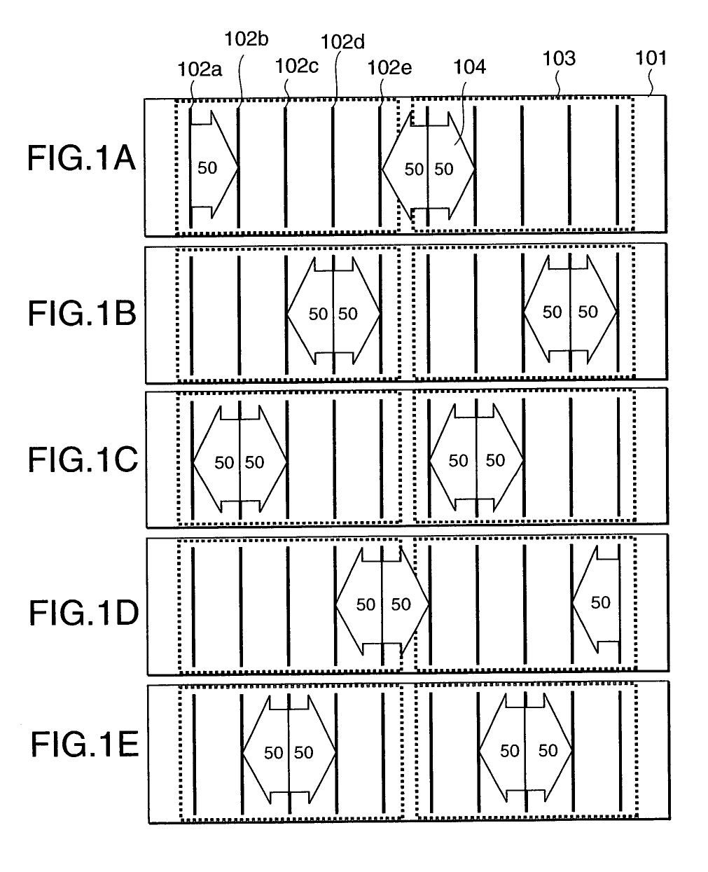

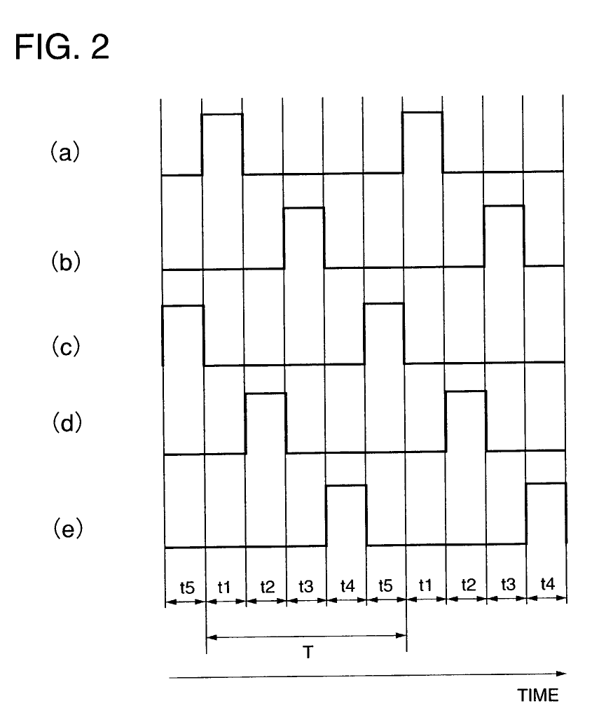

The details of the first embodiment of the invention will be discussed referring to FIGS. 1A through 1E and 2.

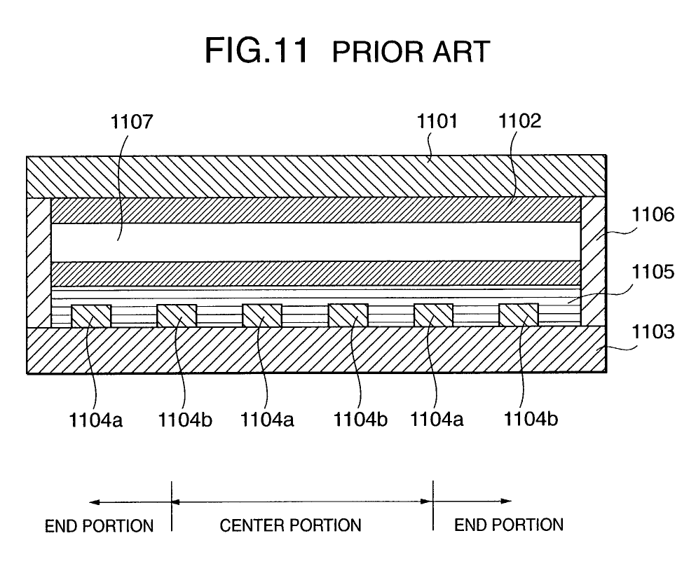

FIGS. 1A to 1E show discharge states according to the first embodiment of the invention, and the structure of a flat type gas discharge tube in use is the same as that shown in FIG. 11 except for the number of electrodes. The gas discharge tube comprises a back glass plate 101 formed of a plane glass and parallel electrodes 102 laid in parallel on the back glass plate 101. Reference numeral “103” indicates an electrode group comprised of a set of five parallel electrodes 102a to 102e. Reference numeral “104” indicates a discharge state or the spreading direction of a discharge produced from the associated parallel electrode 102. The discharge state is affixed with a relative luminance value which is given with “100” being a luminance value obtained in a period T in one discharge zone at the center portion of the flat type gas discharge tube (the space between adjoining electrodes). As two discharges occur in the period T in the same discharge zone, the relative luminance value provided by a single discharge in one discharge zone at the center portion is taken as “50”.

FIG. 2 shows the timing chart of voltages to be applied to the parallel electrodes 102a to 102e in each electrode group 103. In FIG. 2, (a) shows the voltage to be applied to the parallel electrode 102a, (b) shows the voltage to be applied to the parallel electrode 102b, (c) shows the voltage to be applied to the parallel electrode 102c, (d) shows the voltage to be applied to the parallel electrode 102d and (e) shows the voltage to be applied to the parallel electrode 102e.

T indicates one period of the applied voltage, to indicates a period in which the voltage is applied to the parallel electrode 102a, t2 indicates a period in which the voltage is applied to the parallel electrode 102d, t3 indicates a period in which the voltage is applied to the parallel electrode 102b, t4 indicates a period in which the voltage is applied to the parallel electrode 102e and t5 indicates a period in which the voltage is applied to the parallel electrode 102c. The period T consists of to to t5.

The voltages that are applied to the individual electrodes have different application timings and five discharges occur at different locations within the period T.

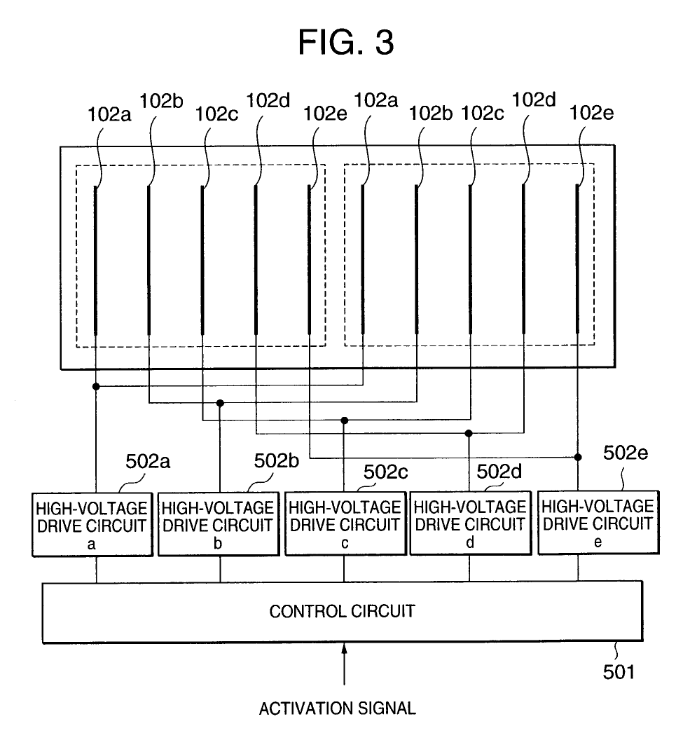

FIG. 3 is a diagram exemplifying the gas discharge tube and a drive circuit which is connected thereto. Reference numeral “501” indicates a control circuit which controls the timings of applying the voltages to respective parallel electrodes, and reference symbols “502a ” to “502e ” indicate high-voltage drive circuits which convert signals outputted from the control circuit 501 to the respective electrodes to voltages needed for the gas discharge tube to generate discharges.

The control circuit 501 is activated by an activation signal generated when an LCD is activated. In case where voltages with the timings shown in FIG. 2 are applied, the control circuit 501 outputs five types of low-voltage signals. The low-voltage signals outputted from the control circuit 501 are inputted to the high-voltage drive circuits 502a to 502e which amplify the signals to voltages needed for the gas discharge tube to generate discharges, e.g., voltages of 1000 V, and apply the amplified voltages to the respective parallel electrodes 102a to 102e. Each of the high-voltage drive circuits 502a to 502e can be constructed by using, for example, an inverter or an FET (Field Effect Transistor).

As those drive circuits are used, the voltage in (a) in FIG. 2 is applied in the period t1 in FIG. 1A, so that discharges occur among the parallel electrodes 102e, 102a and 102b. Note that a discharge occurs only between the parallel electrodes 102a and 102b at the left-hand side end or peripheral portion.

As the voltage in (b) in FIG. 2 is applied in the period t2 in FIG. 1B, discharges occur among the parallel electrodes 102c, 102d and 102e.

In FIGS. 1C and 1E, discharges occur as in FIG. 1B, whereas in FIG. 1D, discharges occur as in FIG. 1A.

With the voltage waveforms in FIG. 2 in use, the same voltage is applied to each electrode group so that discharge areas which are produced by the voltage-applied electrodes (one discharge zone at either end or peripheral portion and two discharge zones at the center portion) are not adjacent to one another in the same period. In case where the period is shifted to the next one, a discharge starts at a place where no discharge has occurred previously.

In other words, a discharge does not occur continuously in the same discharge zone but occurs in one discharge zone after a discharge occurs in another discharge zone. Further, as a voltage is applied only to a single electrode in one electrode group in each period (pulse-voltage application time), the positional relationship between discharge areas that are produced in the entire discharge space is not continuous spatially. That is, the gas discharge tube is driven in such a way that the occurrences of discharges in the tube are dispersed along the time and spatially.

Accordingly, discharges at the end or peripheral portions have the same luminance value as that of discharges in other portions. It is therefore possible to provide a flat type gas discharge tube which suppresses an increase in luminance at the end or peripheral portions and has uniform luminance without using diffusion sheets or the like as needed in the prior art.

Although the number of the parallel electrodes 102a to 102e that constitute each electrode group 103 is set to five in this embodiment, the advantages of the invention can be acquired without limitation to this particular quantity. The number of the electrode groups 103 may take a value other than two without sacrificing the advantages of the invention.

Second Embodiment

According to the second embodiment of the invention, electrodes to which a voltage is not applied are additionally provided at the end or peripheral portions of the flat type gas discharge tube used according to the first embodiment, and discharge-originated light emissions are spatially dispersed by using a plurality of parallel electrodes, thereby suppressing an increase in luminance at the end or peripheral portions of the flat type gas discharge tube.

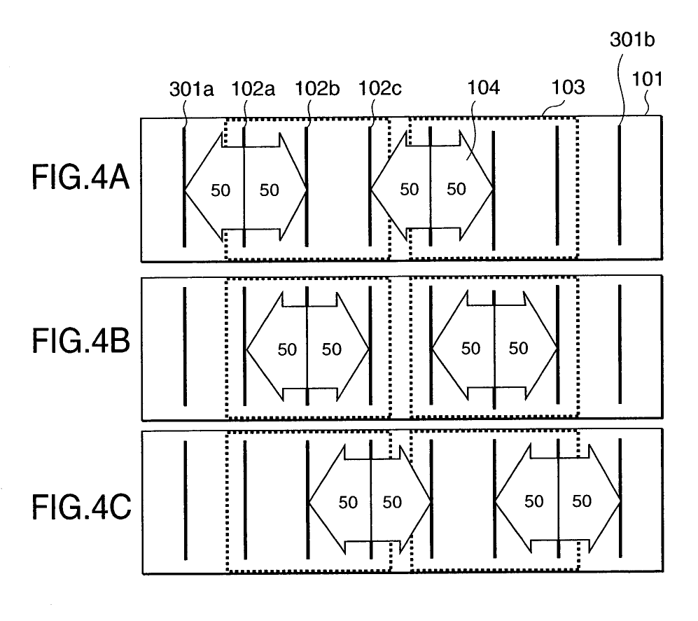

The details of the second embodiment of the invention will be discussed referring to FIGS. 4A through and 8C.

FIGS. 4A to 4C show discharge states according to the second embodiment of the invention. Reference numerals “301a” and “301b” denote spare electrodes or parallel electrodes which are located on the end or peripheral portions of the flat type gas discharge tube and to which no voltage is applied. Each electrode group 103 is comprised of a set of three parallel electrodes 102a to 102c.

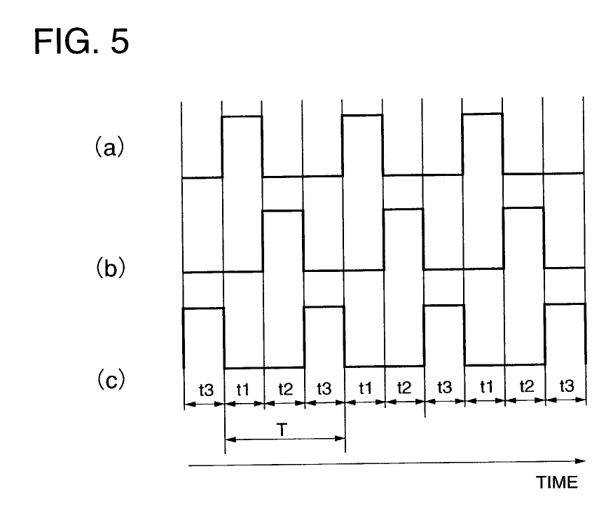

FIG. 5 shows the timing chart of voltages to be applied to the parallel electrodes 102a to 102c in each electrode group 103. In FIG. 5, (a) shows the voltage to be applied to the parallel electrode 102a, (b) shows the voltage to be applied to the parallel electrode 102b, and (c) shows the voltage to be applied to the parallel electrode 102c.

T indicates one period of the applied voltage, t1 indicates a period in which the voltage is applied to the parallel electrode 102a, t2 indicates a period in which the voltage is applied to the parallel electrode 102b, and t3 indicates a period in which the voltage is applied to the parallel electrode 102c. The period T consists of t1 to t3.

The voltages that are applied to the individual electrodes have different application timings and three discharges occur at different locations within the period T The high-voltage drive circuits which are connected to the gas discharge tube are identical to those shown in FIG. 3.

As the voltage in (a) in FIG. 5 is applied in the period t1, FIG. 4A shows discharges which occur among the spare electrode 301a, the parallel electrode 102a and the parallel electrode 102b and discharges which occur among the parallel electrodes 102c, 102a and 102c.

As the voltage in (b) in FIG. 5 is applied in the period t1, FIG. 4B shows discharges which occur among the parallel electrodes 102a, 102b and 102c in both the right and left electrode groups.

As the voltage in (c) in FIG. 5 is applied in the period t1, FIG. 4C shows discharges which occur among the parallel electrodes 102b, 102c and 102a and discharges which occur among the parallel electrode 102b, the parallel electrode 102c and the spare electrode 301b.

As apparent from FIGS. 4A to 4C and FIG. 5, the use of the spare electrodes 301a and 301b can reduce the number of the high-voltage drive circuits as compared with the structure of the first embodiment and discharge areas (two discharge zones) which are produced by the voltage-applied electrodes are not adjacent to each other in each period (pulse-voltage application time). That is, the use of the spare electrodes 301a and 301b can spatially disperse the discharges to thereby suppress an increase in luminance at the end or peripheral portions of the flat type gas discharge tube.

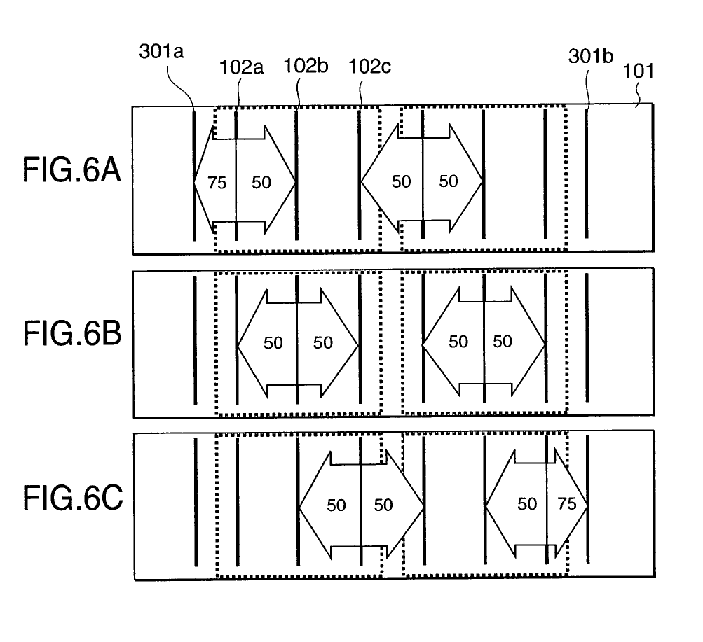

It is to be however noted that as the number of discharges at the end or peripheral portions of the flat type gas discharge tube becomes one in the period T, the luminance value at the end or peripheral portions of the flat type gas discharge tube becomes smaller than the luminance value at the center portion of the flat type gas discharge tube. As shown in FIGS. 6A to 6C, therefore, even the flat type gas discharge tube to which the same voltage is applied to the individual electrodes can have uniform luminance by narrowing the interval between the electrodes at either end or peripheral portion of the flat type gas discharge tube to increase the intensity of an electric field between the electrodes.

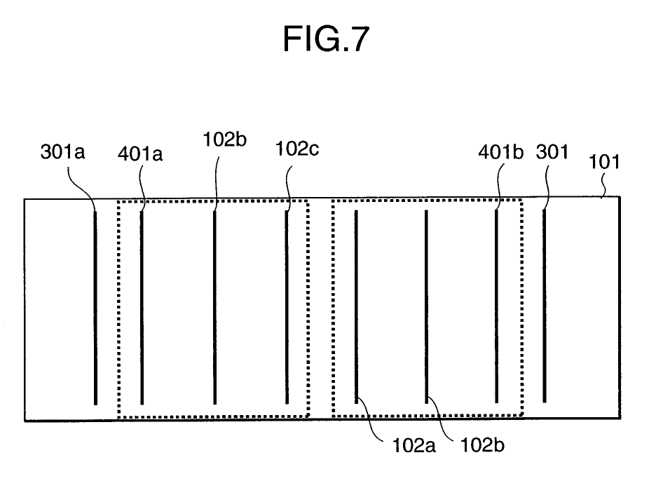

Further, the luminance mottle or unevenness of the gas discharge tube can be suppressed by adjusting the waveform of the voltage that is to be applied to the second parallel electrode from either end or peripheral portion of the gas discharge tube. FIG. 7 shows the layout of the electrodes of the flat type gas discharge tube that has parallel electrodes 401a and 401b, second ones from the end or peripheral portions, to which voltage waveforms different from those in FIG. 5 are applied. In the case of FIG. 7, because the waveforms of the applied voltages differ from those in FIG. 5, discharges occur in such a way as to provide different discharge states different from those shown in FIGS. 6A to 6C.

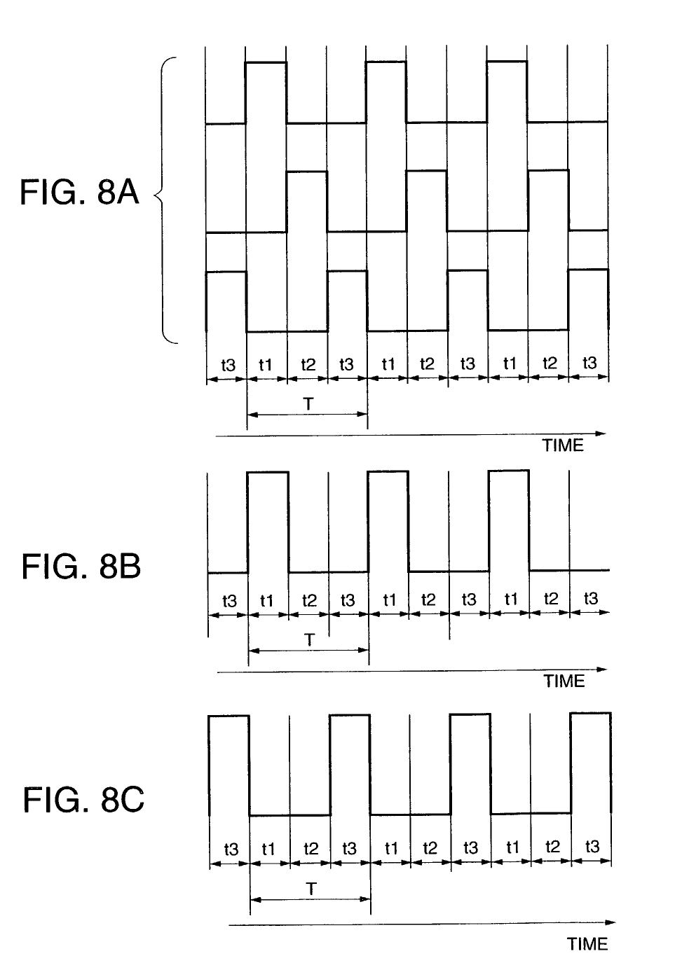

In the electrode layout in FIG. 7, uniform luminance can be acquired by adjusting the luminance at the end or peripheral portions of the flat type gas discharge tube by making the voltage applied to the second parallel electrode 401a, 401b from either end or peripheral portion of the flat type gas discharge tube different from the voltage applied to the parallel electrode at the center portion, as shown in FIGS. 8A to 8C. FIG. 8A shows, from the top, the waveform of the voltage which is applied to the parallel electrode 102a in the right-hand electrode group, the waveform of the voltage which is applied to the parallel electrodes 102b in both electrode groups and the waveform of the voltage which is applied to the parallel electrode 102c in the left-hand electrode group and have the same amplitude as those of the voltages in FIG. 5. FIG. 8B shows the voltage which is applied to the second parallel electrode 401a from the left-hand electrode group shown in FIG. 7 at the same timing as the voltage applied to the parallel electrode 102a at the center portion but has an amplitude different from those of the voltages in FIG. 8A. FIG. 8C shows the voltage which is applied to the second parallel electrode 401b from the right-hand electrode group shown in FIG. 7 at the same timing as the voltage applied to the parallel electrode 102c at the center portion but has an amplitude different from those of the voltages in FIG. 8A.

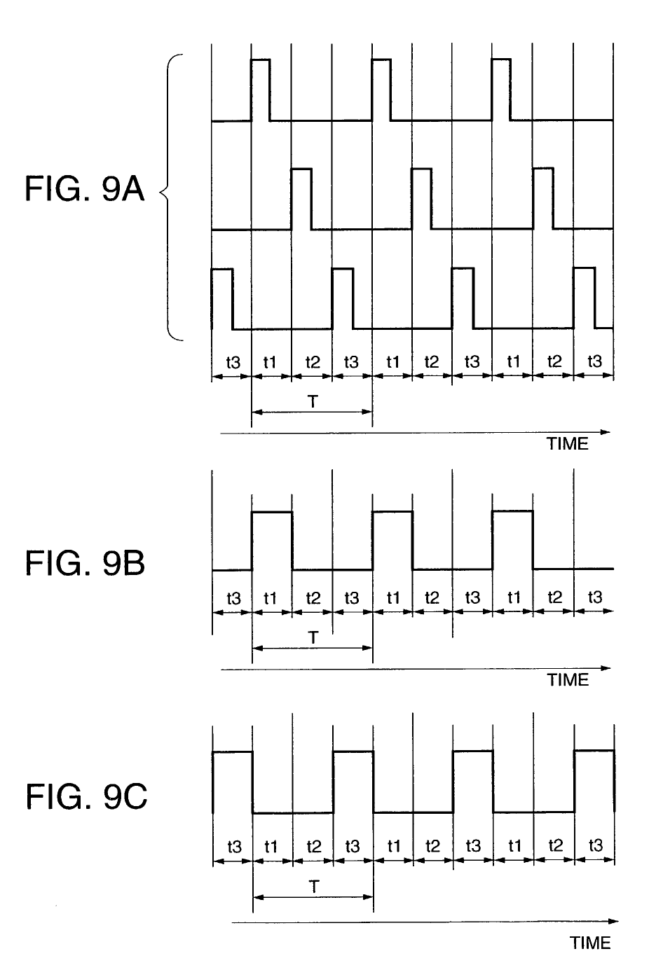

As shown in FIGS. 9A to 9C, uniform luminance can also be acquired by adjusting the pulse widths of voltages applied to the second parallel electrode 401a, 401b from either end or peripheral portion of the flat type gas discharge tube and the parallel electrode at the center portion. FIG. 9A shows, from the top, the waveform of the voltage which is applied to the parallel electrode 102a in the right-hand electrode group, the waveform of the voltage which is applied to the parallel electrodes 102b in both electrode groups and the waveform of the voltage which is applied to the parallel electrode 102c in the left-hand electrode group at the same timings as those in FIG. 5. FIG. 9B shows the voltage which is applied to the second parallel electrode 401a from the left-hand electrode group shown in FIG. 7 at the same timing as the voltage applied to the parallel electrode 102a at the center portion but has a pulse width different from those of the voltages in FIG. 9A. FIG. 9C shows the voltage which is applied to the second parallel electrode 401b from the right-hand electrode group shown in FIG. 7 at the same timing as the voltage applied to the parallel electrode 102c at the center portion but has a pulse width different from those of the voltages in FIG. 9A.

As described above, the flat type gas discharge tube using the spare electrodes 301a and 301b to which no voltage is applied can acquire uniform light emission without using diffusion sheets as used in the prior art by spatially dispersing the occurrences of discharges.

Although the number of the parallel electrodes 102a to 102c that constitute each electrode group 103 is set to three in this embodiment, the advantages of the invention can be acquired without limitation to this particular quantity. The number of the electrode groups 103 may take a value other than two without sacrificing the advantages of the invention.

In short, as the invention can ensure uniform luminance from a flat type gas discharge tube, a single component, which is used for the backlight of an LCD or the like, it is possible to provide a low-cost backlight unit with a simple structure, which is suitable for a large screen.

What is claimed is:

1. A drive method for a gas discharge tube which has two plane glasses, discharge space having a rare gas filled between said plane glasses and a plurality of parallel electrodes arranged on one of said plane glasses and formed into at least one electrode group comprised of at least five parallel electrodes, whereby discharges of said rare gas dispersed spatially and along time are allowed to occur in one electrode group and within one discharge period.

2. The drive method according to claim 1, wherein after a second rare gas discharge is allowed to occur at a place other than a place where a first rare gas discharge has occurred, a third rare gas discharge is allowed to occur within a predetermined period at said place where said first rare gas discharge has occurred.

3. A drive method for a gas discharge tube which has two plane glasses, discharge space having a rare gas filled between said plane glasses, a plurality of parallel electrodes arranged on one of said plane glasses and formed into at least one electrode group comprised of at least three parallel electrodes, and auxiliary electrodes which are located at peripheral portions of said discharge space and to which a predetermined voltage is not applied, whereby spatially dispersed discharges of said rare gas are allowed to occur.

4. The drive method according to claim 3, wherein said auxiliary electrodes are laid out at narrower intervals than layout intervals of said parallel electrodes.

5. The drive method according to claim 3, wherein voltages are applied to each electrode group in such a way that a voltage applied to a center portion of said discharge space is set lower than a predetermined voltage and a voltage applied to a peripheral portion of said discharge space is set higher than said predetermined voltage.

6. The drive method according to claim 3, wherein a time of application of a voltage to each electrode group per unit time is set longer for a center portion of said discharge space than for peripheral portions of said discharge space.

7. A gas discharge tube comprising:
two plane glasses;
discharge space having a rare gas filled between said plane glasses;
a plurality of parallel electrodes arranged on one of said plane glasses and formed into at least one electrode group comprised of at least three parallel electrodes; and
auxiliary electrodes which are located at peripheral portions of said discharge space and to which a predetermined voltage is not applied,
whereby spatially dispersed discharges of said rare gas are allowed to occur.
